(19) United States
(12) Patent Application Publication
(10) Pub. No.: US 2015/0175945 A1
(43) Pub. Date: Jun. 25, 2015

(54) CLEANING FORMULATION AND METHOD

(71) Applicant: Xeros Limited, Rotherham (GB)

(72) Inventors: Alan John Waddon, Sheffield (GB); Robert Andrew Bird, Sheffield (GB); Stephen Derek Jenkins, Middlesbrough (GB)

(21) Appl. No.: 14/412,100

(22) PCT Filed: Jul. 8, 2013
(86) PCT No.: PCT/GB2013/051796

§ 371 Date: Dec. 30, 2014

(30) Foreign Application Priority Data
Jul. 6, 2012 (GB) 1212096.0

(51) Int. Cl. C11D 17/06; C11D 11/00; C11D 3/22; C11D 3/48; C11D 3/00; D06F 35/00; C11D 3/37

(52) U.S. Cl. CPC C11D 17/06; D06F 35/00; C11D 11/0017; C11D 3/3753; C11D 3/48; C11D 3/0021; C11D 3/0036; C11D 3/3776; C11D 3/227

(57) ABSTRACT

The invention provides a formulation and method for the treatment of a substrate, the method comprising the treatment of the substrate with the formulation, the formulation comprising a multiplicity of solid cleaning particles and a multiplicity of dosing particles, wherein the dosing particles comprise at least one host material and at least one releasable material, wherein the host material comprises at least one partially or completely water soluble polymeric material and the at least one releasable material comprises at least one cleaning or post-cleaning agent or other treatment additive for the treatment of the substrate. The method and formulation are advantageously applied to the cleaning of textile fabrics.

### FIELD OF THE INVENTION

This invention is concerned with the cleaning and treatment of substrates using a system comprising solid cleaning particles, which may be polymeric, non-polymeric or a mixture thereof. Specifically, the invention discloses a method which involves the dosing of additives into the wash, using dosing particles mixed in with the solid cleaning particles and a formulation for use in said method.

### BACKGROUND TO THE INVENTION

Aqueous cleaning processes are a mainstay of both domestic and industrial textile fabric washing. This washing generally comprises agitating fabrics in an aqueous solution of detergent, often at elevated temperatures. Supplemental additives, such as fabric conditioners, dye transfer inhibitors, anti-redeposition agents, perfumes or products for enhancing hygiene are customarily added as separate dosing operations, often with the detergent.

On the assumption that the desired degree of cleaning is achieved, the efficacy of textile fabric washing processes is usually characterised by the levels of consumption of energy, water and detergent associated with the processes. In general, the lower the requirements with regard to these three parameters, the more efficient the washing process is deemed. The downstream effect of reduced water and detergent consumption is also significant, as this minimises the need for disposal of aqueous effluent, which is both extremely costly and detrimental to the environment. Similarly, the lower the quantity of any supplemental additive used—whilst providing the desired effect—the more efficient is the operation.

Such washing processes, whether involving domestic washing machines or their industrial equivalents (usually referred to as washer extractors), involve aqueous submersion of fabrics followed by soil removal, aqueous soil suspension, and water rinsing. Higher levels of energy (or temperature), water and detergent usually result in better cleaning. The key issue, however, concerns water consumption, as this sets the energy requirements (in order to heat the wash water), and the level of detergent dosage (to achieve the desired detergent concentration). In addition, the water usage level defines the mechanical action of the process on the fabric, which is another important performance parameter; this is the agitation of the cloth surface during washing, which plays a key role in releasing embedded soil. In aqueous laundry processes, such mechanical action is provided by the water usage level, in combination with the drum design for any particular washing machine. In general, it is found that the higher the water level in the drum, the better the mechanical action. Hence, there is a dichotomy created by the desire to improve overall process efficiency (i.e. the reduction of energy, water and detergent consumption), and the need for efficient mechanical action in the wash.

WO-A-2007/128962 discloses a method and formulation for cleaning a soiled substrate, which greatly reduces the usage of water, energy and detergent while still providing the mechanical action necessary for cleaning. The method comprises the treatment of the moistened substrate with a formulation comprising a multiplicity of polymeric particles, wherein the formulation is free of organic solvents. Preferably, the substrate is wetted so as to achieve a substrate to water ratio of between 1:0.1 to 1:5 w/w, and optionally, the formulation additionally comprises at least one cleaning material, which typically comprises a surfactant, which most preferably has detergent properties. In preferred embodiments, the substrate comprises a textile fibre and the polymeric particles may, for example, comprise particles of polyamides, polyesters, polyalkenes, polyurethanes or their copolymers, but are most preferably in the form of nylon beads. WO-A-2012/056252 describes a method for the most efficient use and removal of such polymeric particles in a cleaning process, and co-pending PCT Application No. GB2012/050085 extends this method to the use of non-polymeric cleaning particles, and mixtures of non-polymeric and polymeric cleaning particles.

The apparatus required to separate polymeric or non-polymeric cleaning particles from the cleaned substrate at the conclusion of the cleaning operation is addressed in WO-A-2010/094959. This provides a novel design of cleaning apparatus requiring the use of two internal drums capable of independent rotation, and which finds application in both industrial and domestic cleaning processes.

In WO-A-2011/064581, there is provided a further apparatus which facilitates efficient separation of cleaning particles from the cleaned substrate at the conclusion of the cleaning operation, and which comprises a perforated drum and a removable outer drum skin which is adapted to prevent the ingress or egress of fluids and solid particulate matter from the interior of the drum, the cleaning method requiring attachment of the outer skin to the drum during a wash cycle, after which the skin is removed prior to operating a separation cycle to remove the cleaning particles, following which the cleaned substrate is removed from the drum.

In a further development of the apparatus, there is disclosed in WO-A-2011/098815 a process and apparatus which provides for continuous circulation of the cleaning particles during the cleaning process, and thereby dispenses with the requirement for the provision of an outer skin.

The improvements to textile fabric cleaning disclosed in WO-A-2007/128962, WO-A-2012/056252, PCT Application No. GB2012/050085, WO-A-2010/094959, WO-A-2011/064581, and WO-A-2011/098815 lead to reductions in the levels of water, energy and detergent used in the cleaning operation. WO-A-2011/128680 goes on to describe a method for the dosing of said detergent into such particle cleaning systems, whereby the detergent is split into its constituent chemical parts, these being added at different times during the cleaning operation. Specifically, it is required that the cleaning parts of the formulation are added before or during the main wash cycle in order to provide the degree of stain removal required, whilst the remaining, more expensive—and hence more value adding—parts of the formulation are added as a post-treatment, usually during rinsing, following removal of the polymeric particles from the wash process. Typically, the cleaning components comprise surfactants, enzymes and oxidising agents or bleaches, whilst the post-treatment components include, for example, anti-redeposition agents, perfumes and optical brighteners. Addition of the cleaning and post-treatment components in this way allows further reduction in levels of use, and hence significant cost savings in comparison to conventional all-in-one detergent formulations.

Whilst the method of WO-A-2011/128680 allows the use of cleaning and post-treatment components in a detergent formulation at different times during the cleaning operation, it still requires transport of each component onto the fabric surface. This is typically achieved by dilution in a quantity of water, then spraying of this diluted solution onto the washload. Although the dilution in this case is much lower than in conventional wash processes, this is still essentially an inefficient means to dose the various detergent components. Furthermore, discrete time periods are required within the wash cycle for such dosing, resulting in an overall cycle time penalty.

A cartridge dosing system as described in WO-A-2011/128676 may also be used for this purpose. In this system, each detergent component is typically concentrated such that a number of dosages are contained within the cartridge, these being used up gradually over a number of wash cycles. Hence, there is a convenience benefit for the user in not having to individually dose each wash. The cartridge itself and the docking system for insertion into the cleaning apparatus can, however, be complex in construction, and hence costly.

In one aspect of the present invention, therefore, the inventors provide a process which addresses the difficulties of dilution and transport of detergent components as hereinbefore described. Thus, there are provided dosing particles which release additives over one or a number of wash cycles for use in conjunction with the solid cleaning particles. Release of the additives may occur through dissolution or disintegration of the dosing particles, or by diffusion from the dosing particles. The dosing particles can contain the detergent components required for effective cleaning and post treatment and, as they are intimately mixed with the solid cleaning particles, they are carried directly to the fabric surface, thereby delivering the detergent components to the washload in the most targeted way possible. Hence, there is neither a requirement for separate dilution in water and spraying in order to deliver the detergent components, nor for a complex cartridge dosing system. Whilst these particles can release additives over one wash cycle, release over a number of washes also delivers the convenience benefit for the user, as previously outlined.

The invention also envisages the dosing of other beneficial additives via the dosing particles. Examples include the addition of antimicrobial agents in order to sterilise the fabric, or of boosted levels of optical brightening agents, anti-redeposition agents, fragrances or dye transfer inhibitors. In each case, the benefit of the dosing particle is its direct and targeted delivery of the specific additive to the fabric surface by the simplest possible means, i.e. in admixture with the solid cleaning particles.

### SUMMARY OF THE INVENTION

The present invention derives from an appreciation on the part of the inventors that cleaning performance as disclosed in WO-A-2007/128962, WO-A-2012/056252 and PCT Application No. GB2012/050085, especially at low temperatures, can be enhanced by the release of cleaning agents or post-cleaning agents, or other treatment additives, from dosing particles intimately mixed with the solid cleaning particles.

Thus, according to a first aspect of the present invention, there is provided a formulation comprising a multiplicity of solid cleaning particles and a multiplicity of dosing particles, wherein said dosing particles comprise at least one host material and at least one releasable material, wherein said host material comprises at least one partially or completely water soluble polymeric material and said at least one releasable material comprises at least one cleaning or post-cleaning agent or other treatment additive for the treatment of the substrate.

In certain embodiments, said formulation is used for the cleaning of soiled substrates and said at least one releasable material comprises at least one cleaning agent

Most particularly, said at least one releasable material comprises at least one cleaning agent, most particularly at least one detergent, which typically comprises at least one surfactant. Optionally, said at least one releasable material additionally or solely comprises at least one post-cleaning agent.

Thus, said cleaning agents and post-cleaning agents are especially cleaning chemicals or post-cleaning chemicals which are typically components of the detergent formulation used in a conventional wash process. Cleaning agents are, therefore, typically surfactants, enzymes, oxidising agents or bleaches, whilst suitable post-cleaning agents include, but are not limited to, optical brightening agents, anti-redeposition agents, dye-transfer inhibition agents and fragrances.

Said host material comprises a non-active polymeric or non-polymeric material which serves to transport the releasable material to the washload surface in a controlled manner but plays no active part in the cleaning process. Various materials may be employed for this purpose, since the dosing particles can be of several different types.

Thus, in certain embodiments of the invention, said polymeric materials are hydrogels, which comprise polymeric materials and water in a state of gelation. The water content in the hydrogels may generally be between 30 and 98% w/w, but is typically 40-85% w/w. The polymeric material in the hydrogel typically comprises, for example, poly(vinyl alcohol) (PVOH), poly(vinyl acetate) (PVA), poly(ethyl vinyl alcohol) (EVOH), poly(ethylene glycol) (PEG), poly(acrylates) (PAC), gelatine, hyaluronic acid, carboxymethyl cellulose (CMC), starch, alginate gel or other poly(saccharides), or blends or copolymers of these materials, or salts thereof. In said embodiments, the releasable material may be physically dispersed within the hydrogel or, alternatively, may be dissolved within the water component of the hydrogel in order to form the dosing particles. By altering the molecular weight and degree of hydrolysis of the hydrogel, it is possible to control the rate of release of the releasable material from the formulation when in use. Thus, in embodiments when the PVOH is in the form of a hydrogel, poly(vinyl alcohol) having a degree of hydrolysis of 98% or higher is typically used for the purposes of the invention.

In alternative embodiments of the invention, the dosing particles comprise solid pellets formed by compacting host materials comprising polymeric powders and/or non-polymeric powders under a combination of pressure and temperature, together with the at least one releasable material and, optionally, additional materials such as disintegrants, lubricants and binders. The hardness—and, hence, rate of dissolution and release of the at least one releasable material when in use—can be varied by adjustment of the pelletising pressure and temperature. It will be readily appreciated that a mixture of one or more polymers, may readily be prepared by pelletisation of powders. Examples of suitable polymers forming powders which are suitable for pelletisation include chitosan, lactose, cellulose, starch, micro crystalline cellulose (MCC), croscarmellose sodium, hydroxypropylcellulose (HPC), hydroxypropylmethylcellulose (HPMC), hydroxyethylcellulose (HEC), poly(vinyl alcohol) (PVOH), poly(vinyl acetate) (PVA), poly(vinyl pyrrolidinone) (PVP), crosslinked PVP, poly(ethylene glycol) (PEG) and gelatin, or salts thereof. Poly(vinyl alcohol) having a degree of hydrolysis of 94% is typically suitable for the purposes of the invention.

In further alternative embodiments of the invention, the dosing particles may comprise degradable host materials, including polymers such as poly(lactic acid) (PLA), poly(glycolic acid) (PGA), poly(vinyl alcohol) (PVOH) (Mowiflex®—a melt extrudable form of the polymer) poly(vinyl acetate) (PVA), poly(vinyl pyrrolidinone) (PVP), polyamides, polyesters and blends and copolymers of these materials, or salts thereof. In said embodiments, the releasable material is mixed with the polymer by melt compounding, for example in a twin screw extruder.

Said dosing particles typically survive for more than one substrate treatment operation and, as a consequence, are re-usable in further such operations.

The solid cleaning particles may comprise polymeric and/or non-polymeric cleaning particles.

Solid polymeric cleaning particles may comprise either foamed or unfoamed polymeric materials. Furthermore, the polymeric particles may comprise polymers which are either linear or crosslinked.

Solid polymeric cleaning particles preferably comprise polyalkenes such as polyethylene and polypropylene, polyamides, polyesters or polyurethanes. Typically, however, said polymeric particles comprise polyamide or polyester particles, most particularly particles of nylon, polyethylene terephthalate or polybutylene terephthalate, often in the form of beads. Said polyamides and polyesters are found to be particularly effective for aqueous stain/soil removal, whilst polyalkenes are especially useful for the removal of oil-based stains. Each of said polymeric solid cleaning particles is typically substantially cylindrical or spherical in shape and has an average density in the range of 0.5-2.5 g/cm³ and an average volume in the range of 5-275 mm³.

Optionally, copolymers of the above polymeric materials may be included in said polymeric cleaning particles. Specifically, the properties of the polymeric materials may be tailored to specific requirements by the inclusion of monomeric units which confer particular properties on the copolymer. Thus, the copolymers may be adapted to attract particular staining materials by comprising monomers which, inter alia, are ionically charged, or include polar moieties or unsaturated organic groups.

Suitable solid non-polymeric cleaning particles may comprise particles of glass, silica, stone, wood, or any of a variety of metals or ceramic materials. Suitable metals include, but are not limited to, zinc, titanium, chromium, manganese, iron, cobalt, nickel, copper, tungsten, aluminium, tin and lead, and alloys thereof. Suitable ceramics include, but are not limited to, alumina, zirconia, tungsten carbide, silicon carbide and silicon nitride. Each of said solid non-polymeric cleaning particles is typically substantially cylindrical or spherical in shape and has an average density in the range of 3.5-12.0 g/cm³ and an average volume in the range of 5-275 mm³.

In certain embodiments of the invention, a mixture of polymeric and non-polymeric solid cleaning particles can be used.

According to a second aspect of the invention, there is provided a method for the treatment of a substrate, said method comprising the treatment of the substrate with a formulation according to the first aspect of the invention.

The method of the invention is carried out in an aqueous environment in the presence of limited quantities of water. In other words, the amount of water present during the performance of the method of the invention is far less than in the case of the methods of the prior art, thereby providing one of the principal benefits associated with said method.

Most particularly, said treatment method comprises a method for the cleaning of a soiled substrate and typically, therefore, said at least one releasable material comprises at least one cleaning agent, most particularly at least one detergent, which typically comprises at least one surfactant. Optionally, said at least one releasable material additionally or solely comprises at least one post-cleaning agent and/or at least one other treatment additive.

According to the method of the present invention, said releasable materials are delivered directly to the substrate surface by means of controlled localised release from dosing particles containing these agents. In this way the cleaning and post-cleaning agents, and any other treatment additives, are delivered in the most targeted manner possible, thereby reducing the amount of releasable material required to achieve the desired cleaning, post-cleaning or treatment effect. Furthermore, there is no requirement for the use of complex cartridge or other dosage devices, and no need to use additional water to transport the agent to the fabric surface. The release of said releasable material from the dosing particle may be controlled by selection of a suitable host material as previously indicated, such that it completely releases in one wash cycle, or over a number of wash cycles. In the latter case, the dosing particles may remain stored in a suitable washing apparatus used for the performance of the method of the invention, thereby removing the need for separate dosing of each wash cycle, and providing greater convenience for the user.

In embodiments of the invention wherein the dosing particles comprise degradable host materials, the operation of the method of the invention, under the typical conditions of the cleaning operation, causes such dosing particles to be eroded either by chemical degradation—for example by hydrolysis in alkaline conditions—and/or by physical dissolution and/or mechanical wear.

Polymeric or non-polymeric solid cleaning particles, or mixtures thereof, are typically added at a particle to substrate addition level of 0.1:1-30:1 by dry mass of substrate (washload).

The substrate treated by the claimed method may comprise any of a wide range of substrates, including, for example, plastics materials, leather, paper, cardboard, metal, glass or wood. In practice, however, said substrate most preferably comprises a textile fibre, which may be either a natural fibre, such as cotton, or a synthetic textile fibre, for example nylon 6,6 or a polyester, or a blend of natural and synthetic fibres.

The dosing particles are added at a ratio from 0.1-50.0% w/w of the total mass of the cleaning particle formulation. Each of said dosing particles is substantially cylindrical or spherical in shape and has an average density in the range of 0.5-2.5 g/cm³ and an average volume in the range of 5-275 mm³.

Further embodiments of the invention envisage a method for the treatment of a substrate wherein the surface of a substrate is treated with a post-cleaning agent, the method comprising treating the substrate with a multiplicity of solid cleaning particles and a multiplicity of dosing particles, wherein said dosing particles comprise additives which are free from cleaning agents. Said embodiments are again carried out in the presence of wash water, and involve the use of dosing particles containing post-cleaning agents. Examples of such embodiments may, for example, involve dosing with an optical brightening agent, an anti-redeposition agent, a fragrance, or a dye transfer inhibition agent.

A third aspect of the invention provides a method for the cleaning of a cleaning apparatus, said method comprising the treatment of the internal systems of the apparatus with a formulation comprising a multiplicity of solid cleaning particles and a multiplicity of dosing particles, wherein said dosing particles comprise at least one host material and at least one releasable material, wherein said host material comprises at least one partially or completely water soluble polymeric material and said at least one releasable material comprises an antimicrobial agent. In the performance of said method, the formulation is circulated such that the antimicrobial agent is released within the washing apparatus internal water storage areas or conduits during idle periods between wash cycles, thereby enhancing the hygiene of the apparatus itself.

In typical embodiments of the invention, said dosing particles survive for more than a single wash and, therefore, are re-usable. In such embodiments, the dosing particles are collected at the end of the treatment and are then available for re-use in further substrate treatments. After one or more re-uses, the particles become exhausted and any residues have to be removed for disposal.

Thus, a fourth aspect of the invention provides a method for the removal of dosing particles or residues thereof from a cleaning apparatus during or after the treatment of a substrate, said method comprising the solubilisation of said dosing particles. Thus, typically, the temperature or pH of the system may be adjusted so as to immediately and completely solubilise the dosing particles by means of a thermal or pH trigger in order to facilitate their complete removal from the system without detriment to the solid cleaning particles.

The wash system provided by the present invention is designed to improve mechanical interaction between all of the particles of the cleaning formulation and the fabrics, and facilitates the easy removal of the solid cleaning particles from the fabrics after the cleaning or other post-cleaning process is complete, thereby facilitating their re-use in subsequent processes according to the method. The invention, however, is not limited to procedures for cleaning, post-cleaning and other treatments of fabrics, and is applicable to any solid particle cleaning process, such as dish washing or carpet cleaning.

### DETAILED DESCRIPTION OF THE INVENTION

The first aspect of the invention envisages a formulation comprising a multiplicity of solid cleaning particles and a multiplicity of dosing particles, wherein said dosing particles comprise at least one host material and at least one releasable material, as hereinbefore defined.

In said formulation, suitable examples of dosing particles include, but are not limited to, poly(vinyl alcohol) (PVOH) hydrogels wherein the PVOH has a degree of hydrolysis of 98% or higher, and an average molecular weight of 89,000 to 186,000 Daltons. Most suitably, these PVOH hydrogels are blended with carboxymethyl cellulose (CMC), wherein the PVOH has a degree of hydrolysis exceeding 99% and an average molecular weight of 146,000 to 186,000 Daltons, and the CMC has an average molecular weight of 250,000 Daltons.

Typically, the cleaning agents dosed by the dosing particles comprise surfactants, enzymes, oxidising agents and bleach, whilst the post-cleaning agents include, for example, optical brightening agents, anti-redeposition agents, dye transfer inhibiting agents and fragrances.

The cleaning agents may optionally also include, for example, builders, chelating agents, dye transfer inhibiting agents, dispersants, enzyme stabilizers, catalytic materials, bleach activators, polymeric dispersing agents, clay soil removal agents and suds suppressors.

Examples of suitable surfactants may be selected from non-ionic and/or anionic and/or cationic surfactants and/or ampholytic and/or zwitterionic and/or semi-polar nonionic surfactants. The surfactant is typically present at a level of from about 0.1%, from about 1%, or even from about 5% w/w of the dosing particle mass up to about 99.9%, to about 80%, to about 35%, or even to about 30% w/w of the dosing particle mass, or any of the ranges defined thereby.

Examples of suitable enzymes include, but are not limited to, hemicellulases, peroxidases, proteases, other cellulases, other xylanases, lipases, phospholipases, esterases, cutinases, pectinases, keratanases, reductases, oxidases, phenoloxidases, lipoxygenases, ligninases, pullulanases, tannases, pentosanases, malanases, [beta]-glucanases, arabinosidases, hyaluronidase, chondroitinase, laccase, mannanase and amylases, or mixtures thereof. A typical combination may comprise a mixture of enzymes such as protease, lipase, cutinase and/or cellulase in conjunction with amylase.

Optionally, enzyme stabilisers may also be included amongst the cleaning agents. In this regard, enzymes for use in detergents may be stabilised by various techniques, for example by the incorporation of water-soluble sources of calcium and/or magnesium ions in the compositions.

Examples of suitable bleach compounds include, but are not limited to, peroxygen compounds, including hydrogen peroxide, inorganic peroxy salts, such as perborate, percarbonate, perphosphate, persilicate, and mono persulphate salts (e.g. sodium perborate tetrahydrate and sodium percarbonate), and organic peroxy acids such as peracetic acid, monoperoxyphthalic acid, diperoxydodecanedioic acid, N,N′-terephthaloyl-di(6-aminoperoxycaproic acid), N,N′-phthaloylaminoperoxycaproic acid and amidoperoxyacid. Bleach activators include, but are not limited to, carboxylic acid esters such as tetraacetylethylenediamine and sodium nonanoyloxybenzene sulfonate.

Suitable builders include, but are not limited to, the alkali metal, ammonium and alkanolammonium salts of polyphosphates, alkali metal silicates, alkaline earth and alkali metal carbonates, aluminosilicates, polycarboxylate compounds, ether hydroxypolycarboxylates, copolymers of maleic anhydride with ethylene or vinyl methyl ether, 1,3,5-trihydroxybenzene-2,4,6-trisulphonic acid, and carboxymethyl-oxysuccinic acid, various alkali metal, ammonium and substituted ammonium salts of polyacetic acids such as ethylenediamine tetraacetic acid and nitrilotriacetic acid, as well as polycarboxylates such as mellitic acid, succinic acid, oxydisuccinic acid, polymaleic acid, benzene 1,3,5-tricarboxylic acid, carboxymethyloxysuccinic acid, and soluble salts thereof.

One or more copper, iron and/or manganese chelating agents and/or one or more dye transfer inhibiting agents may also be included. Suitable dye transfer inhibiting agents include chitosan, polyvinylpyrrolidone polymers (crosslinked or uncrosslinked), polyamine N-oxide polymers, copolymers of N-vinylpyrrolidone and N-vinylimidazole, polyvinyloxazolidones, polyvinylimidazoles, sodium bentonite, calcium bentonite, montmorillionite, kaolinite or mixtures or salts thereof.

The cleaning agents can also optionally contain dispersants. Suitable water-soluble organic dispersants are homo- or co-polymeric polycarboxylic acids, or their salts, in which the polycarboxylic acid may comprise at least two carboxyl radicals separated from each other by not more than two carbon atoms.

Examples of post-cleaning anti-redeposition agents include, but are not limited to, CMC, polyacrylates and polyethylene glycol (PEG), or salts thereof.

Suitable post-cleaning fragrances include, but are not limited to, multi-component organic chemical formulations which can contain alcohols, ketones, aldehydes, esters, ethers and nitrile alkenes, and mixtures thereof. Commercially available compounds offering sufficient substantivity to provide residual fragrance include Galaxolide (1,3,4,6,7,8-hexahydro-4,6,6,7,8,8-hexamethylcyclopenta(g)-2-benzopyran), Lyral (3- and 4-(4-hydroxy-4-methyl-pentyl)cyclohexene-1-carboxaldehyde and Ambroxan ((3aR,5aS,9aS,9bR)-3a,6,6,9a-tetramethyl-2,4,5,5a,7,8,9,9b-octahydro-1H-benzo[e][1]benzofuran). One example of a commercially available fully formulated perfume is Amour Japonais supplied by Symrise® AG.

Suitable post-cleaning optical brightening agents include, but are not limited to, several organic chemical classes, of which the most popular are stilbene derivatives, whilst other suitable classes include benzoxazoles, benzimidazoles, 1,3-diphenyl-2-pyrazolines, coumarins, 1,3,5-triazin-2-yls and naphthalimides. Examples of such compounds include, but are not limited to, 4,4′-bis[[6-anilino-4(methylamino)-1,3,5-triazin-2-yl]amino]stilbene-2,2′-disulfonic acid, 4,4′-bis[[6-anilino-4-[(2-hydroxyethyl)methylamino]-1,3,5-triazin-2-yl]amino]stilbene-2,2′-disulphonic acid, disodium salt, 4,4′-bis[[2-anilino-4-[bis(2-hydroxyethyl)amino]-1,3,5-triazin-6-yl]amino]stilbene-2,2′-disulfonic acid, disodium salt, 4,4′-bis[(4,6-dianilino-1,3,5-triazin-2-yl)amino]stilbene-2,2′-disulphonic acid, disodium salt, 7-diethylamino-4-methylcoumarin, 4,4′-bis[(2-anilino-4-morpholino-1,3,5-triazin-6-yl)amino]-2,2′-stilbene-disulfonic acid, disodium salt, and 2,5-bis(benzoxazol-2-yl)thiophene.

Other treatment additives which may be dosed according to the invention include antimicrobial agents, suitable examples of which include, but are not limited to, ionic silver containing zeolites, benzalkonium chloride, Triclosan® and silver nitrate.

In certain embodiments of the invention, the dosing particles comprise a host material comprising a hydrogel of a blend of PVOH and CMC, and a releasable material comprising a silver containing zeolite, the w/w % of PVOH, CMC and silver containing zeolite being 56, 35 and 9%, respectively.

In further embodiments, the dosing particles comprise a host material of PVOH hydrogel, whilst the releasable material comprises benzalkonium chloride, the ratio of materials in the particles being PVOH:benzalkonium chloride (w:w) 9.6:1.

The solid cleaning and dosing particles are of such a shape and size as to allow for good flowability and intimate contact with a soiled substrate, which typically comprises a textile fabric. In the context of the present invention, therefore, said particles typically comprise cylindrical or spherical beads. It is found that the combination of particle size, shape and density is such that the mechanical interaction of the particle with the fabric is optimised, it being sufficiently vigorous to provide effective cleaning but, at the same time, uniform and gentle enough to reduce fabric damage when compared with conventional aqueous processes. It is, in particular, the uniformity of the mechanical action generated by the chosen particles across the entire fabric surface that is the key factor in this regard. Such uniform mechanical action is also the key to localised and controlled application of the cleaning agents, post-cleaning agents and other treatment additives from the dosing particles across the entire substrate surface.

The particle parameters are also controlled so as to allow for easy separation of the particles from the washload at the end of the wash process. Thus, particle size and shape may be controlled in order to minimise entanglement with the substrate, and the combination of suitable particle density and high free volume (ullage) in the washing machine tumbling process together promote particle removal. This is especially relevant in the case of fabric treatment processes.

In the method according to the second aspect of the invention, the ratio of solid cleaning particles to substrate is generally in the range of from 30:1 to 0.1:1 w/w (dry mass of substrate (washload)), preferably in the region of from 10:1 to 1:1 w/w, with particularly favourable results being achieved with a ratio of between 5:1 and 1:1 w/w, and most particularly at around 2:1 w/w. Thus, for example, for the cleaning of 5 g of fabric, 10 g of solid cleaning particles would be employed, and therefore up to a further 5 g of dosing particles would be used in addition to dose cleaning and post-cleaning agents, and other treatment additives.

In order to provide additional lubrication to the system, and thereby improve the transport properties within the system, water is added to the system. Optionally, a soiled substrate may be moistened by wetting with mains or tap water prior to loading into a cleaning apparatus. In any event, water is added to the process such that the washing treatment is carried out so as to achieve a water to substrate ratio which is typically between 2.5:1 and 0.1:1 w/w; more frequently, the ratio is between 2.0:1 and 0.8:1, with particularly favourable results having been achieved at ratios such as 1.5:1, 1.2:1 and 1.1:1.

As previously noted, the method of the invention finds particular application in the cleaning of textile fibres and fabrics. The conditions employed in such a cleaning system are very much in line with those which apply to the conventional wet cleaning of textile fibres and, as a consequence, are generally determined by the nature of the fabric and the degree of soiling. Thus, typical procedures and conditions are in accordance with those which are well known to those skilled in the art, with fabrics generally being treated according to the method of the invention at, for example, temperatures of between 5 and 95° C. for a duration of between 10 minutes and 1 hour, then being rinsed in water and dried. The release of additives from the dosing particles is controlled such that these release completely in one wash, or over a series of washes, for the increased convenience of the user.

The localised delivery of cleaning and post-cleaning agents, and other treatment additives, to the fabric surface by the dosing particles is the predominant feature that ensures excellent cleaning and post-cleaning performance. No problems are observed with solid cleaning or dosing particles adhering to the fibres at the conclusion of the cleaning operation, and all particles may subsequently be removed from the substrate of the washload. The method of the invention may particularly advantageously be carried out by using, for example, cleaning apparatus as disclosed in WO-A-2010/094959, WO-A-2011/064581 and WO-A-2011/098815.

Additionally, as previously noted, it has been demonstrated that re-utilisation of the solid cleaning particles is possible. Furthermore, dosing particles typically survive for more than one wash and can be similarly re-used.

Release of the cleaning agents, post-cleaning agents or other treatment additives onto the soiled substrate from the dosing particle may occur through mechanical erosion experienced by the particle in the wash procedure, by chemical erosion (such as hydrolysis) of the particle, by enzymatic degradation of the particle, by physical dissolution of the particle, by disintegration of the particle, or by diffusion of the releasable material from the particle, or by a combination of some or all of these effects.

Further embodiments of the invention envisage a method for treating the surface of a substrate with an additive, the method comprising treating the soiled substrate with solid cleaning particles and wash water, and mixing in additional dosing particles containing an appropriate treatment additive. Suitable examples could include the release of an antimicrobial agent onto a fabric surface for sterilisation purposes.

The invention also envisages a method by which the dosing particles release an antimicrobial agent within the washing apparatus internal water storage areas or conduits during idle periods between wash cycles, thereby enhancing the hygiene of the apparatus itself.

In addition, the invention also provides for the complete removal of dosing particles or residues of dosing particles without detriment to the solid cleaning particles, by use of, for example, a thermal or pH trigger to promote their rapid dissolution.

The method according to the second aspect of the invention typically involves the cleaning of a soiled substrate and comprises, in sequence, the steps of:
(a) washing the soiled substrate with a multiplicity of solid cleaning particles and a multiplicity of dosing particles;
(b) performing a first extraction of excess water;
(c) performing a first separation of said solid cleaning and dosing particles;
(d) rinsing;
(e) performing a second extraction of excess water;
(f) optionally repeating steps (d) and (e) at least once; and
(g) performing a second separation of said solid cleaning and dosing particles.

The method of the second aspect of the present invention may be used for either small or large scale batchwise processes, and it finds application in both domestic and industrial cleaning processes.

The method of the invention may be applied to the cleaning of any of a wide range of substrates including, for example, plastics materials, leather, paper, cardboard, metal, glass or wood. In practice, however, said method is principally applied to the cleaning of substrates comprising textile fibres and fabrics, and has been shown to be particularly successful in achieving efficient cleaning of textile fabrics which may, for example, comprise either natural fibres, such as cotton, or man-made and synthetic textile fibres, for example nylon 6,6, polyester, cellulose acetate, or fibre blends thereof.

The conditions employed in such cleaning systems when applied to textile fabrics do, however, allow the use of surprisingly lower wash temperatures from those which typically apply to the conventional wet cleaning of textile fabrics and, as a consequence, offer significant environmental and economic benefits.

The invention will now be further illustrated, though without in any way limiting the scope thereof, by reference to the following examples.

### EXAMPLES

### Example 1

### Disinfection of a Contaminated Cloth at Room Temperature and Neutral pH (Silver Containing Zeolite)

Approximately 18.5 g of PVOH (>99% hydrolysed, molecular weight 146,000 to 186,000 Daltons, Sigma Aldrich Catalogue No. 363,065) and 3.0 g of a silver containing zeolite (Microsilver BG Tec Plus™, Biogate AG, Nurnberg, Germany), were added to 230 g of water (see Table 1). The PVOH was dissolved in the water by a combination of heating and stirring to form a 7.4% w/w solution, with the silver containing zeolite being dispersed in this solution as a fine particulate. The solution was then allowed to cool to approximately 40° C., before 11.5 g of CMC of molecular weight approximately 250,000 Daltons (Sigma Aldrich catalogue number 419,311) was added and mixed by manual stirring. The preparation creamed during the mixing of the CMC to form a white paste. This paste was then spread on to a non-stick surface to a thickness of about 10 mm before drying in an air oven at 65° C. for 72 hours (Sample 1).

A control sample (Control 1) was prepared in a similar manner to that described above, but with the silver containing zeolite omitted. The exact quantities used in the preparation of Sample 1 and Control 1 are shown in Table 1. The corresponding percentage compositions (w/w) are shown in Table 2.

TABLE 1
COMPOSITIONS OF SAMPLE 1 AND
CONTROL 1 BEFORE DRYING

| | Sample 1 | Control 1 |
|---|---|---|
| PVOH | 18.50 g | 18.64 g |
| Water | 229.95 g | 230.20 g |
| Microsilver BG Tec Plus ™ | 3.00 g | 0 g |
| CMC | 11.49 g | 11.49 g |

TABLE 2
PERCENTAGE COMPOSITIONS OF SAMPLE
1 AND CONTROL 1 (W/W) BEFORE DRYING

| | Sample 1 | Control 1 |
|---|---|---|
| PVOH | 7.0% | 7.2% |
| Water | 87.5% | 88.4% |
| Microsilver BG Tec Plus ™ | 1.1% | 0% |
| CMC | 4.4% | 4.4% |

The compositions of Sample 1 and Control 1 (w/w) after drying are as given in Table 3.

TABLE 3
PERCENTAGE COMPOSITIONS OF SAMPLE
1 AND CONTROL 1 (W/W) AFTER DRYING

| | Sample 1 | Control 1 |
|---|---|---|
| PVOH | 56.0% | 62.0% |
| CMC | 35.0% | 38.0% |
| Microsilver BG Tec Plus ™ | 9.1% | 0% |

Approximately 1.8 g of the dried Sample 1 and Control 1 were weighed to a precision of ±0.0005 g. These dry weights are denoted w₁. Both materials were then soaked in water overnight to form swollen hydrogels. Any excess water was blotted off their surfaces, and the samples were re-weighed. The weights of the swollen hydrogels are denoted w₂. The swelling ratios of the hydrogels were then calculated from:

Swelling ratio(before tumbling)=w₂/w₁

The swollen Sample 1 and Control 1 hydrogels were then cut into pieces approximately 2-4 mm in size, and the pieces of each hydrogel type were separately placed in sealed plastic boxes (about 17×12×5.5 cm in dimension) with 6 g of water, each with a piece of cloth of dimensions roughly 10×10 cm inoculated with 1 ml of Pseudomonas Aeruginosa suspension. The level of inoculation was 2.5×10⁸ colony forming units (cfu)/cloth. Inoculation was performed by Microbiological Consultant Services (MCS) of Stoney Middleton, Hope Valley, U.K. The inoculated cloths were transported in sterile plastic bags.

A second control cloth sample (Control 2) was prepared. This sheet was also inoculated with 1 ml of Pseudomonas Aeruginosa suspension to a level of 2.5×10⁸ cfu/cloth and it, too, was placed in a sealed box with 6 ml of water, as described above. This box, however, did not contain any hydrogel. All of the boxes (Sample 1, Control 1 and Control 2) were then tumbled in a tumble dryer at room temperature for 60 minutes at 50 rpm.

After tumbling, the various cloths and hydrogels were recovered. The cloths were sent in sterile plastic bags to MCS, where they were analysed for microbiological activity. The cloths were suspended in 9 ml of a diluent, and vigorously agitated to release any bacteria remaining. The resulting suspensions were analysed using a standard plate count method, after incubation on Tryptone Soya Agar at (31±1°) C. for 3 days.

The swelling ratios of the hydrogels after tumbling were found by blotting the hydrogels (to remove excess surface water) and re-weighing to give the weight of the wet hydrogel, w₃. The pieces of hydrogel were then fully dried at 65° C., then weighed again, to give the dry weight after tumbling, w₄. The swelling ratios of the hydrogels after tumbling were found from:

Swelling ratio after tumbling=w₃/w₄

The % dry weight loss of the hydrogel during tumbling was calculated from:

% Dry weight loss=(w₁−w₄)×100/w₁

The numbers of colony forming units per cloth after incubation are shown in Table 4.

TABLE 4
CFU/CLOTH FOR SAMPLE 1, CONTROL
1 AND CONTROL 2 CLOTHS

| | cfu/Cloth (Bacteria) |
|---|---|
| Sample 1 | 9.8 × 10³* |
| Control 1 | E > 10⁷ |
| Control 2 - No Hydrogel | E > 10⁷ |

E = Estimated count; Initial Ps aeruginosa Inoculum = 2.5 × 10⁸ cfu/cloth
*= Colonies observed were predominantly those of Gram positive cocci

The dry and swollen weights of the hydrogels before and after tumbling are shown in Table 5.

TABLE 5
WEIGHTS OF SAMPLE 1 AND CONTROL
1 BEFORE AND AFTER TUMBLING

| | Sample 1 | Control 1 |
|---|---|---|
| Dry weight before tumbling, w₁ | 1.775 g | 1.775 g |
| Weight. of swollen hydrogel before tumbling, w₂ | 8.212 g | 9.823 g |
| Weight. of swollen hydrogel after tumbling, w₃ | 8.967 g | 10.231 g |
| Dry weight after tumbling, w₄ | 1.463 g | 1.434 g |

The swelling ratios of the hydrogels before and after tumbling are shown in Table 6.

TABLE 6
SWELLING RATIOS OF SAMPLE 1 AND CONTROL
1 BEFORE AND AFTER TUMBLING

| | Sample 1 | Control 1 |
|---|---|---|
| Swelling ratio before tumbling | 4.6 | 5.5 |
| Swelling ratio after tumbling | 6.1 | 7.1 |

The percentage dry weight losses occurring as a result of tumbling for Sample 1 and Control 1 are shown in Table 7.

TABLE 7
PERCENTAGE DRY WEIGHT LOSS
DURING TUMBLING (W/W)

| | Dry Weight Loss |
|---|---|
| Sample 1 | 17.6% |
| Control 1 | 19.2% |

It is evident from Table 4 that the cloth treated with the hydrogel with silver containing zeolite antimicrobial (Sample 1) showed fewer bacteria (by factors of over 1000) than either the cloth treated with the hydrogel without silver antimicrobial (Control 1), or the cloth treated with only water (Control 2). The weight losses of the Sample 1 hydrogel and the Control 1 hydrogel during the tumbling treatment were 17.6% and 19.2%, respectively (see Table 7).

The dry weight losses indicate that, during the tumbling action, some of the material forming the gel dissolved, and transferred into the water and cloth contained within the box. In the case of the Sample 1 hydrogel, some of the silver containing zeolite also transferred to the water and the cloth, and hence effectively disinfected the cloth. By way of comparison, the Control 1 hydrogel, which showed similar dry weight loss to the Sample 1 hydrogel, had no such disinfecting effect.

### Example 2

### Disinfection of a Contaminated Cloth at Room Temperature and Neutral pH (Benzalkonium Chloride)

A series of PVOHs of different degrees of hydrolysis and molecular weights was used as carriers for the water soluble antimicrobial agent benzalkonium chloride. The PVOHs were obtained from Sigma Aldrich, and are listed in Table 8 by their key characteristics of degree of hydrolysis and molecular weight.

TABLE 8
PROPERTIES OF POLYVINYL ALCOHOLS USED

| Aldrich Catalogue | % | Molecular Weight |
|---|---|---|
| Number | Hydrolysis | (Daltons) |
| 363,138 | 98-99 | 31,000-50,000 |
| 363,154 | 98-99 | 85,000-124,000 |
| 341,584 | >99 | 89,000-98,000 |
| 363,065 | >99 | 146,000-186,000 |

Samples were prepared by mixing 7.5 g of each PVOH, 107 g of water and 1.5 g of 50% aqueous benzalkonium chloride (Sigma Aldrich catalogue number 63,249); these mixtures were heated with manual stirring until the PVOH dissolved. A series of control samples without benzalkonium chloride was also prepared in a similar fashion. The solutions were cast into non-stick containers and dried at 65° C. for 3 days. The amounts used (to ±0.005 g) are shown in Table 9.

TABLE 9
QUANTITIES OF REAGENTS IN PVOH SAMPLES
LOADED WITH BENZALKONIUM CHLORIDE

| | PVOH 363,138 | | PVOH 363,154 | | PVOH 341,584 | | PVOH 363,065 | |
|---|---|---|---|---|---|---|---|---|
| PVOH (g) | 7.54 | 7.52 | 7.52 | 7.52 | 7.55 | 7.50 | 7.52 | 7.49 |
| 50% | 1.51 | 0 Control | 1.51 | 0 Control | 1.57 | 0 Control | 1.51 | 0 Control |
| Benzalkonium | | 363,138 | | 363,154 | | 341,584 | | 363,065 |
| Chloride (g) | | | | | | | | |
| Water (g) | 107.07 | 107.25 | 107.02 | 107.33 | 107.42 | 107.17 | 107.06 | 107.40 |

The % contents (w/w) of benzalkonium chloride in the dried samples containing the reagent are shown Table 10.

TABLE 10
WEIGHT % COMPOSITION OF BENZALKONIUM
CHLORIDE CONTAINING SAMPLES

| | PVOH 363,138 | | PVOH 363,154 | | PVOH 341,584 | | PVOH 363,065 | |
|---|---|---|---|---|---|---|---|---|
| PVOH (% w/w) | 90.90 | 100 | 90.88 | 100 | 90.58 | 100 | 90.88 | 100 |
| Benzalkonium | 9.10 | 0 Control | 9.12 | 0 Control | 9.42 | 0 Control | 9.12 | 0 Control |
| Chloride (% w/w) | | 363,138 | | 363,154 | | 341,584 | | 363,065 |

The dry gels were swollen in water at 65° C. for 45 minutes, and excess water was blotted off their surfaces. The gels were then cut into pieces roughly 2-4 mm in size, and the pieces of each hydrogel type were separately placed in sealed plastic boxes (approximately 17×12×5.5 cm in dimension) with 6 g of water, each with a piece of cloth about 10×10 cm inoculated with 1 ml of Pseudomonas Aeruginosa suspension. The level of inoculation was 2.4×10⁸ cfu/cloth. Inoculation was again carried out by MCS. The inoculated cloths were transported in sterile plastic bags. The boxes were then tumbled in a tumble dryer at room temperature for 60 minutes at 50 rpm.

In addition to the cloths tumbled with pieces of hydrogel, another piece of cloth inoculated with 1 ml of Pseudomonas Aeruginosa suspension as described above, was also tumbled in a sealed box with 6 ml of water at room temperature for 60 minutes at 50 rpm but in the absence of any hydrogel (Control 2).

After tumbling, the cloths were removed, placed in sterile plastic bags and sent to MCS for microbiological analysis. These cloths were suspended in 9 ml of a diluent and vigorously agitated to release any bacteria remaining. The resulting suspensions were analysed using a standard plate count method after incubation on Tryptone Soya Agar at (31±1°) C. for 3 days. The results are shown in Table 11.

TABLE 11
COLONY FORMING UNITS PER CLOTH FOR PVOH
GELS CONTAINING BENZALKONIUM CHLORIDE,
VOH CONTROL GELS AND CONTROL 2

| | Colony Forming Units per |
|---|---|
| Cloth | cloth (bacteria) |
| PVOH 363,138 with benzalkonium chloride | <10 |
| PVOH 363,154 with benzalkonium chloride | <10 |
| PVOH 341,584 with benzalkonium chloride | <10 |
| PVOH 363,065 with benzalkonium chloride | <10 |
| PVOH 363,138 control | 1.2 × 10⁷ |
| PVOH 363,154 control | 1.6 × 10⁷ |
| PVOH 341,584 control | 7.9 × 10⁶ |
| PVOH 363,065 control | 1.1 × 10⁷ |
| Control 2 - cloth only | 1.3 × 10⁷ |

Initial Ps aeruginosa Inoculum = 2.4 × 10⁸ cfu/cloth

Table 11 shows that the cloths treated with the hydrogels with benzylalkonium chloride showed fewer bacteria (by factors of over 10⁶) after incubation than either the cloth treated with hydrogel without the antimicrobial, or a cloth treated with only water (Control 2). This leads to the conclusion that the disinfecting effect is due to the benzylalkonium chloride releasing from the hydrogels, and this is occurring at room temperature and neutral pH.

### Example 3

### Dye Transfer Inhibition from Polyvinyl Alcohol (PVOH) Compounded with Crosslinked Polyvinyl Pyrollidone (PVP)

This example shows dye transfer inhibition effect imparted by a melt compounded bead containing the active agent, cross-linked PVP, and, as host material, polyvinyl alcohol. It also shows that the DTI effect persists over multiple washes (at least 5).

### Material Preparation

Cross-linked PVP (Polyplasdone XL-10, supplied by Ashlands Speciality Ingredients, Wayne N.J. 07470, USA) was compounded with a PVOH supplied by Kuraray Europe GmbH (Frankfurt D-65926, Germany) using a Leistritz ZSE 27 HP 44D twin screw extruder with a 27 mm screw diameter. The grade of PVOH was Mowiflex LP TC 661. The level of loading of PVP was 25% (by weight). The PVOH had a degree of hydrolysis of approximately 94%. PVOH and PVP were fed from separate feeders at 15 and 5 kg/hour, respectively, giving an overall output of 20 kg/hour and a PVP content of 25%.

The temperature profile of the extruder barrel was as shown in Table 12:

TABLE 12
TEMPERATURE IN EXTRUDER ZONES
FOR EXTRUSION OF PVOH/25% PVP

| Zone | 1 | 2 | 3 | 4 | 5 | 6 | 7 | 8 | 9 | 10 | die |
|---|---|---|---|---|---|---|---|---|---|---|---|
| ° C. | 50 | 160 | 200 | 210 | 210 | 210 | 210 | 210 | 200 | 195 | 190 |

The temperature of extrusion was therefore above the melting point of the PVOH but below the degradation temperature of the cross-linked PVP. A vacuum line was connected to the extrusion barrel to de-gas the material and prevent foaming. Extruded lace was cooled sequentially in water and air. The pellet size cut was approximately 3 mm.

### Dye Transfer Inhibition (DTI)

DTI testing was carried out in a domestic Beko WM5120W washing machine (5 kg capacity) with Technyl XA 1493 (Nylon 6,6 as supplied by Solvay, Lyon, France) cleaning beads.

The source of red dye was two new, unwashed red tee shirts (Fruit of the Loom, size XXL). Ballast consisted of used polyester clean-room suits. The weight of the washload is defined as the weight of the tee shirts plus the weight of the ballast. The weight ratio of Technyl XA 1493 cleaning beads to washload was 2:1.

One and a half sebum sheets (one sheet measuring 23×61 cm) (Product code SBL 2004, WFK Testgewebe GmbH, D-41379, Germany) and four cotton cloths (17×28 cm) were also added to the washload. The materials making up the wash are listed in Table 13:

TABLE 13
RED DYE TRANSFER INHIBITION -
ITEMS INCLUDED IN WASH

| Technyl XA1493 beads | 2.8 | kg |
|---|---|---|
| Polyester clean room suits | 0.95 | kg |
| New, unwashed red cotton | 0.45 | kg |
| tee shirts (Fruit of the Loom) | | |
| Sebum cloths | One and a half | |
| White cotton cloths (17 × 28 cm) | 4 | cloths |
| PVOH/25% PVP | 500 | g |

It should be noted that the wash contained 500 g of PVOH/25% PVP; the weight of PVP present at the start of the program was therefore 125 g.

The items for each wash load were placed in a net mesh bag; beads were mixed thoroughly with the fabric materials. Fabric materials were inserted into the mesh bag in layers to disperse items evenly throughout the mesh bag and the mesh bag was sealed by tying.

The mesh bag was washed in a Beko domestic washing machine using a 40° C. cotton cycle with 11.2 g of Xeros Pack I detergent and the spin speed set was 1200 rpm. The ratio (by weight) of Xeros Pack I detergent to wash load was therefore approximately 8 g per kg of washload.

At the end of the wash cycle, white cotton cloths were recovered, dried by hanging at room temperature and then analysed for colour character using a Konica Minolta CM-3600A photospectometer to obtain values of L*, a* and b*. The size of aperture on the photospectrometer was 25.4 mm, using 100% UV component and excluding the specular component. Measurements on 16 areas of the cloths (four areas per cloth) were averaged.

### Further Wash Runs

The beads (Technyl and PVOH/PVP beads) were recovered after the first wash. Another wash load with new tee shirts, sebum sheets and white cloths, and clean polyester ballast was prepared. The PVOH/PVP beads were added to the new load and another wash was carried out, as described above (1.2). This procedure was repeated for a total of 5 washes. Values of CEI, L*, a* and b* on the white cloths were recorded after every wash.

### Results

Table 14 shows the values of a* which were recorded; the control is a run without dosing beads. Table 14 also shows values of Da*, where Da* is defined as the change in a* with respect to the value of a* for virgin, unwashed cloth. It also shows the percentage reduction Da* for each wash where:

% reduction in Da*=100×{1−(Da*/Da*_{control}}

This is a measure of the effectiveness of dye transfer inhibition. If the a* value of washed cloth returns to that of virgin cloth, this parameter is 100%; if the a* value is unchanged from that of the control (i.e. no DTI from dosing beads), this parameter is zero.

TABLE 14
RED DYE TRANSFER INHIBITION - 500 GPVOH BEADS WITH 25% CROSS-LINKED PVP

| | Virgin cloth | Control | Wash 1 | Wash 2 | Wash 3 | Wash 4 | Wash 5 | mean |
|---|---|---|---|---|---|---|---|---|
| a* | −0.19 ± 0.02 | 5.49 ± 1.12 | 1.87 ± 0.16 | 2.49 ± 0.17 | 2.09 ± 0.31 | 2.84 ± 0.28 | 3.04 ± 0.21 | |
| Da* | 0 | 5.68 | 2.06 | 2.68 | 2.28 | 3.03 | 3.23 | |
| % reduction in Da* | | 0% | 64% | 53% | 60% | 47% | 43% | 53% |

Thus, it is seen from Table 14 that 500 g PVOH/25% PVP beads have inhibited transfer of red dye to the white cloth and that the effect persists over at least 5 washes. The mean “percentage reduction in Da*” over the 5 washes was 53%. It was also instructive to calculate the mean “percentage reduction in Da*” per g of DTI in the material; this was calculated by dividing the mean “percentage reduction in Da*” by the amount of DTI material originally in the dosing beads. For instance, in this example, 500 g of dosing beads with 25% PVP material was used; therefore 125 g of DTI material was used.

Accordingly, the “mean percentage reduction in Da*” per g of DTI=53/125=0.43%/g.

### Example 4

### Dye Transfer Inhibition from Polyvinyl Alcohol (PVOH) Compounded with Chitosan

This example shows dye transfer inhibition effect imparted by a melt compounded bead containing the active agent, chitosan, and, as host material, polyvinyl alcohol. It also shows that the DTI effect persists over multiple uses (at least 5).

### Material Preparation

Chitosan (ChitoClear 40500, Primex EHF, 580 Siglufjordur, Iceland) was compounded with a PVOH supplied by Kuraray (Mowiflex LP TC 661) using the Leistritz ZSE 27 HP 44D twin screw extruder with a 27 mm screw diameter (as described in Example 3). The level of loading of chitosan was 25% (by weight) and the PVOH had a degree of hydrolysis of approximately 94%. PVOH and chitosan were fed from separate feeders at 15 and 5 kg/hour, respectively, giving an overall output of 20 kg/hour and a chitosan content of 25%.

The temperature profile of the barrel was the same as described in Example 3. The temperature of extrusion was therefore above the melting point of the PVOH but below the degradation temperature or melting temperature of the chitosan. A vacuum line was connected to the extrusion barrel to de-gas the material and prevent foaming. Extruded lace was cooled sequentially in water and air. The pellet size cut was approximately 3 mm in size.

### Dye Transfer Inhibition

The experimental protocol for assessment of DTI was as described above in Example 3, except that 500 g of PVOH/25% chitosan dosing beads were mixed with the cleaning beads. The total amount of chitosan present was therefore 125 g. A “control” run (without dosing beads) was also carried out.

### Results

Table 15 shows the values of a* which were recorded. The Beko washing machine used for this experiment was not the same as in Example 3 and, hence, values of a* cannot be directly compared; however, the “percentage reduction in Da*” values do allow comparison between different machines. The control was a run without dosing beads.

TABLE 15
RED DYE TRANSFER INHIBITION. - 500 G PVOH BEADS WITH 25% CHITOSAN

| | Virgin cloth | Control | Wash 1 | Wash 2 | Wash 3 | Wash 4 | Wash 5 | mean |
|---|---|---|---|---|---|---|---|---|
| a* | −0.19 ± 0.02 | 8.17 ± 0.38 | 1.99 ± 0.14 | 2.16 ± 0.21 | 2.24 ± 0.35 | 2.38 ± 0.11 | 2.53 ± 0.19 | |
| Da* | 0 | 8.36 | 2.18 | 2.35 | 2.43 | 2.57 | 2.72 | |
| % reduction in Da* | | 0% | 74% | 72% | 71% | 69% | 67% | 71% |

Thus, it is seen from Table 15 that 500 g PVOH/25% chitosan beads have inhibited transfer of red dye to the white cloth and that the effect persists over at least 5 washes. The mean value of “percentage reduction in Da*” over the 5 washes was 71%. The quantity of chitosan in 500 g of beads with 25% chitosan was 125 g.

The “mean percentage reduction in Da*” per g of DTI is therefore obtained from:

Mean percentage reduction in Da*”per g=71/125%/g=0.57%/g

Hence, the values of “percentage reduction in Da*” per g of DTI material for PVOH/25% chitosan are larger than for PVOH/25% PVP (Example 3), indicating that chitosan is more effective DTI agent.

### Example 5

### Dye Transfer Inhibition from Polyvinyl Alcohol (PVOH) Compounded with Sodium Bentonite

This example shows the dye transfer inhibition effect imparted by a melt compounded bead containing, as the active agent, sodium bentonite and, as host material, polyvinyl alcohol. It also shows that the DTI effect persists over 4 washes.

### Material Preparation

Sodium bentonite (Sigma Aldrich Chemicals, Gillingham, UK, product number 285234) was compounded with a PVOH Mowiflex LP TC 661 supplied by Kuraray using an APV MP2030 30 mm screw (28 L/D) twin screw extruder at the facilities of Smithers Rapra, Shawbury, UK. PVOH and bentonite were fed through separate feeders at 5.4 and 0.96 kh/hour, respectively, giving an overall output of 6.36 kg/hour. The level of loading of sodium bentonite was, therefore, 15.1% (by weight). This was the highest achievable and is less than the loading of PVP (Example 3) and chitosan (Example 4), where 25% loading was achieved.

The temperature profile of the barrel was as shown in Table 16:

TABLE 16
TEMPERATURE IN EXTRUDER ZONES FOR
EXTRUSION OF PVOH/15% SODIUM BENTONITE

| Zone | 1 | 2 | 3 | 4 | 5 | 6 | 7 | 8 | 9 | die |
|---|---|---|---|---|---|---|---|---|---|---|
| ° C. | 140 | 220 | 220 | 210 | 210 | 210 | 200 | 200 | 200 | 200 |

The pellet size cut was approximately 3 mm.

### Dye Transfer Inhibition

The experimental protocol was as described above in Example 3 except, in this case, 500 g of PVOH/15% sodium bentonite dosing beads were used; the total weight of bentonite present was therefore 75 g. A “control” run (without dosing beads) was also carried out.

### Results

The values of a* which were recorded are shown in Table 17, which also shows values of Da* and % reduction in Da*, as defined above. Mean values were calculated over 4 washes (where reduction in a* was found).

TABLE 17
RED DYE TRANSFER INHIBITION - PVOH BEADS WITH 15% SODIUM BENTONITE

| | Virgin cloth | Control | Wash 1 | Wash 2 | Wash 3 | Wash 4 | (Wash 5) | Mean* |
|---|---|---|---|---|---|---|---|---|
| a* | −0.19 ± 0.02 | 5.49 ± 1.12 | 3.16 ± 0.51 | 3.68 ± 0.81 | 4.28 ± 0.26 | 3.96 ± 0.29 | (6.78 ± 0.50) | |
| Da* | 0 | 5.68 | 3.35 | 3.87 | 4.47 | 4.15 | No reduction | |
| %reduction in Da* | | 0% | 41% | 32% | 21% | 27% | No reduction | 30% |

Hence, Table 17 shows that 500 g of PVOH/15% sodium bentonite beads have inhibited transfer of red dye to the white cloth and that the DTI effect persists over 4 washes. The DTI effect was, however, not apparent in wash 5. This is in contrast to Example 3 (PVP) and Example 4 (chitosan), where DTI was maintained over at least 5 washes.

The mean value of “percentage reduction in Da*” over the 4 washes was 30%. The quantity of bentonite in 500 g of beads with 15% sodium bentonite was 75 g.

The “mean percentage reduction in Da*” per g of DTI material is therefore obtained from:

Mean percentage reduction in Da*”per g=30/75%/g=0.40%/g

It is noticeable that the DTI extended over only 4 washes for the PVOH/15% sodium bentonite beads, whilst DTI was maintained over at least 5 washes for PVOH/25% PVP (Example 3) and PVOH/25% chitosan (Example 4).

The values of “percentage reduction in Da*” are also lower than those for either PVOH/25% PVP (Example 3) or PVOH/25% chitosan (Example 4); however, the loading of DTI material for PVOH/bentonite was also lower. A comparison of effectiveness of different DTI materials can be made from “percentage reduction in Da*” per gram of DTI in the material. These figures are shown in Table 18.

TABLE 18
EFFECTIVENESS OF DTI MATERIALS

| | “mean percentage reduction in |
|---|---|
| | Da*” per g |
| PVP | 0.43 |
| Chitosan | 0.57 |
| Sodium bentonite | 0.40 |

It is therefore seen from Table 18 that chitosan is the most effective DTI material, followed by PVP and then sodium bentonite.

### Example 6

### Dye Transfer Inhibition from Foamed Polyvinyl Alcohol (PVOH) Compounded with Chitosan

This example shows the dye transfer inhibition effect imparted by a melt compounded bead containing the active agent, chitosan, and, as host material, polyvinyl alcohol. This is a “fast release bead” that releases most of the DTI material very quickly, in this case over only 3 uses.

### Material Preparation

Chitosan (Sigma Aldrich Chemicals product number 448869) was compounded with a PVOH (Mowiflex LP TC 661) supplied by Kuraray using an APV MP2030 30 mm twin screw extruder (28L/D) at the facilities of Smithers Rapra, Shawbury, UK. PVOH and chitosan were fed through separate feeders at 6.4 and 1.6 kg/hour, respectively, giving an overall output of 8 kg/hour The level of loading of chitosan was therefore 20% (by weight).

The temperature profile of the barrel was as shown in Table 19:

TABLE 19
TEMPERATURE IN EXTRUDER ZONES FOR
EXTRUSION OF PVOH/20% CHITOSAN

| Zone | 1 | 2 | 3 | 4 | 5 | 6 | 7 | 8 | 9 | die |
|---|---|---|---|---|---|---|---|---|---|---|
| ° C. | 150 | 230 | 230 | 220 | 220 | 220 | 210 | 210 | 210 | 210 |

The temperature of extrusion was therefore above the melting point of the PVOH but below that of chitosan. The pellet size cut was approximately 3 mm. There was significant out-gassing in the extruder barrel which caused foaming of the beads.

### Dye Transfer Inhibition

The experimental protocol was as described above in Example 3 except, in this case, 200 g of PVOH/20% chitosan dosing beads were used (equivalent to 40 g of chitosan). A “control” run (without dosing beads) was also carried out.

### Results

The values of a* which were recorded are shown in Table 20, which also shows values of Da* and % reduction in Da*, as defined above.

TABLE 20
RED DYE TRANSFER INHIBITION - 200 G OF PVOH/20% CHITOSAN

| | Virgin cloth | Control | Wash 1 | Wash 2 | Wash 3 |
|---|---|---|---|---|---|
| a* | −0.19 ± 0.02 | 8.17 ± 0.38 | 3.48 ± 0.42 | 3.26 ± 0.29 | 6.19 ± 0.64 |
| Da* | 0 | 8.36 | 3.67 | 3.45 | 6.38 |
| % reduction in Da* | | 0% | 56% | 59% | 24% |

Table 20 shows that PVOH/20% chitosan beads have inhibited transfer of red dye to the white cloth and that the DTI effect persists beyond single use. However, because of the foamed nature of the bead, the beads were consumed in fewer washes than in Example 4 where the bead was unfoamed. The lifetime of the beads was estimated to be 3-4 washes.

### Example 7

### Comparison of DTI Between Chitosan Released from Dosing Beads and Chitosan Powder

This Example compares the effectiveness of DTI of a chitosan dosing bead that releases chitosan to that of the same amount of loose chitosan powder added to a wash. It shows the dosing bead is as effective as the powder and has the advantage of increased convenience for the end-user.

Example 4 shows that chitosan in a dosing bead effectively reduces dye transfer for up to at least 5 washes. In this example, the amount of chitosan released per wash was estimated and then a wash was conducted using the same amount of chitosan, but added as a loose powder. The DTI of chitosan in the form of a) dosing beads and b) powder was therefore compared.

Approximately 50 PVOH/chitosan compounded beads were removed after Wash 5 in Example 4. These were dried in a fan oven at approximately 65° C. for 90 minutes. Unused PVOH/25% chitosan beads were dried in the same way. The weight of approximately 50 dried beads was found; from this the percentage weight loss was determined and the amount of chitosan released over 5 washes was estimated. The weights of the beads are shown in Table 21.

TABLE 21
WEIGHT OF PVOH/25% CHITOSAN BEADS AFTER
5 WASH CYCLES AND WEIGHT OF UNUSED BEADS

| | Beads after 5 washes | Unused beads |
|---|---|---|
| Number of beads | 48 | 49 |
| Weight of beads, g | 0.27 g | 1.61 g |
| Average weight of beads, mg | 5.6 mg | 32.9 mg |

The results in Table 21 allow the percentage weight loss of PVOH/chitosan beads over 5 washes to be calculated at 83.0%, or 16.6% per wash.

In Example 4, 500 g of PVOH/25% chitosan beads were added at the start; this contained 125 g of chitosan. Assuming that there was no preferential removal of PVOH or chitosan, it may therefore be estimated that, after 5 washes, 103.7 g (=83.0%×125 g) of chitosan has been released. Assuming that the quantity of chitosan released per wash was the same over the 5 washes, it can then be estimated that 20.7 g of chitosan was released per wash.

Accordingly, an experiment was carried out using the protocol described in Example 3 with 20.7 g of loose chitosan powder (ChitoClear 40500).

### Results

The value of a* for 20.7 g of loose chitosan powder was 1.84±0.28. In Example 4, when chitosan was released from dosing beads, the mean value of a* over 5 washes was 2.26. The difference between the values is less than 1 unit, meaning that it cannot be detected by human eye, i.e. to the human eye, multi-dosing beads which release chitosan have equivalent DTI performance as the equivalent quantity of loose chitosan powder. Multi-dosing beads, however, have the advantage of much greater convenience for the end-user.

### Example 8

### DTI from Spheronised Pellets Containing Chitosan

This example shows dye transfer inhibition effect imparted by a spheronised bead containing, as the active agent, chitosan, and, as host materials, microcrystalline cellulose (MCC) and polyvinyl alcohol. It also shows that the DTI effect persists for multiple uses.

### Material Preparation

Materials listed in Table 22 were wet granulated in a household food mixer.

TABLE 22
FORMULATION OF SPHERONISED PELLETS

| | | |
|---|---|---|
| Chitosan (Sigma Aldrich 448869) | 100 | g |
| MCC (Avicel) (FMC Biopolymer, | 100 | g |
| Philadelphia, PA, USA) | | |
| 10% polyvinyl alcohol solution | 40 | ml |
| (Elvanol 85-82) (DuPont, | | |
| Wilmington, DE, USA) | | |

| | |
|---|---|
| Mix of water, vinegar, methylated | 160 ml water, 20 ml vinegar, |
| spirits | 20 ml methylated spirits |

The materials listed in Table 22 were extruded through a Caleva Bench top Variable density Extruder using a 4 mm custom made die plate. The extrudate was then spheronised using a Caleva Bench Top MBS 250 Spheroniser to form approximately spherical pellets of diameter of approximately 4 mm. These were dried in an oven overnight at approximately 60° C. The role of the PVOH was to bind the chitosan with the MCC.

### Dye Transfer Inhibition

The experimental protocol was as described above in Example 3 except, in this case, 100 g of Chitoan/MCC/PVOH spheronised dosing beads were used (equivalent to 49 g of chitosan). A “control” run (without dosing beads) was also carried out.

### Results

The results are shown in Table 23.

TABLE 23
RED DYE TRANSFER INHIBITION - SPHERONISED
PELLETS CONTAINING CHITOSAN

| | Control | Wash 1 | Wash 2 | Wash 3 | Wash 4 | Wash 5 |
|---|---|---|---|---|---|---|
| a* | 8.17 ± 0.38 | 4.50 ± 0.87 | 5.20 ± 0.67 | 4.23 ± 0.62 | 4.08 ± 0.52 | 4.47 ± 0.42 |

Thus, it can be seen from Table 23 that the spheronised dosing beads have been effective in reducing dye transfer and that the effect persists over at least 5 washes. It should be noted that the chitosan content in the beads was 49 g.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1-63. (canceled)

64. A formulation comprising a multiplicity of solid cleaning particles and a multiplicity of dosing particles, wherein said dosing particles comprise at least one host material and at least one releasable material, wherein said host material comprises at least one partially or completely water soluble polymeric material and said at least one releasable material comprises at least one cleaning and/or post-cleaning agent and/or other treatment additive for the treatment of the substrate.

65. A formulation as claimed in claim 64 for the cleaning of a soiled substrate, wherein said at least one releasable material comprises at least one cleaning agent.

66. A formulation as claimed in claim 64 wherein said at least one releasable material comprises at least one post-cleaning agent, or wherein said at least one releasable material comprises at least one post-cleaning agent which comprises at least one optical brightening agent, anti-redeposition agent, fragrance or dye transfer inhibitor.

67. A formulation as claimed in claim 64 wherein said at least one other treatment additive comprises at least one anti-microbial agent, or wherein said at least one other treatment additive comprises at least one anti-microbial agent selected from ionic silver containing zeolites, benzalkonium chloride, Triclosan® and silver nitrate.

68. A formulation as claimed in claim 66 wherein said at least one post-cleaning agent comprises at least one anti-redeposition agent selected from CMC, polyacrylates or polyethylene glycol (PEG), or salts thereof.

69. A formulation as claimed in claim 66 wherein said at least one post-cleaning agent comprises at least one dye transfer inhibitor selected from chitosan, polyvinylpyrrolidone polymers (crosslinked or uncrosslinked), polyamine N-oxide polymers, copolymers of N-vinylpyrrolidone and N-vinylimidazole, polyvinyloxazolidones, polyvinylimidazoles, sodium bentonite, calcium bentonite, montmorillionite, kaolinite or mixtures or salts thereof.

70. A formulation as claimed in claim 64 wherein said cleaning agent comprises at least one detergent, or wherein said cleaning agent comprises at least one detergent which comprises at least one surfactant which is selected from non-ionic and/or anionic and/or cationic surfactants and/or ampholytic and/or zwitterionic and/or semi-polar non-ionic surfactants, optionally wherein said surfactant is present at a level of from 5% to 30% of the dosing particle mass.

71. A formulation as claimed in claim 64 wherein said at least one cleaning agent comprises at least one enzyme, oxidising agent or bleach, and/or wherein said at least one cleaning agent additionally comprises builders, chelating agents, dye transfer inhibiting agents, dispersants, enzyme stabilizers, catalytic materials, bleach activators, polymeric dispersing agents, clay soil removal agents and/or suds suppressors.

72. A formulation as claimed in claim 64 wherein said dosing particles comprise additives which are free from cleaning agents.

73. A formulation as claimed in claim 72 which comprises an antimicrobial agent for release onto a fabric surface for sterilisation purposes.

74. A formulation as claimed in claim 64 wherein said host material comprises a non-active polymeric material comprising a hydrogel, preferably wherein the water content in said hydrogel is between 30 and 98% w/w and/or wherein the polymeric material in said hydrogel is selected from polyvinyl alcohol, poly(vinyl acetate), poly(ethyl vinyl alcohol), poly(ethylene glycol), poly(acrylates), gelatine, hyaluronic acid, carboxymethyl cellulose, starch, alginate gel or other poly(saccharides), and blends or copolymers of these materials, or salts thereof.

75. A formulation as claimed in claim 64 wherein said dosing particles comprise solid pellets formed by compacting host materials comprising polymeric powders and/or non-polymeric powders under a combination of pressure and temperature together with the at least one releasable material, preferably wherein said dosing particles additionally comprise at least one material selected from disintegrants, lubricants and binders, and/or preferably wherein said polymers forming powders which are suitable for pelletisation may be selected from chitosan, lactose, cellulose, starch, micro crystalline cellulose, croscarmellose sodium, hydroxypropylcellulose, hydroxypropylmethylcellulose, hydroxyethylcellulose, poly(vinyl alcohol), poly(vinyl acetate), poly(vinyl pyrrolidinone) which may be crosslinked or uncrosslinked, poly(ethylene glycol) and gelatin, or salts thereof.

76. A formulation as claimed in claim 64 wherein said dosing particles comprise at least one degradable host material, or wherein said dosing particles comprise at least one degradable host material selected from poly(lactic acid), poly(glycolic acid), polyvinyl alcohol, poly(vinyl acetate), poly(vinyl pyrrolidinone), polyamides, polyesters and blends and copolymers of these materials, or salts thereof, preferably wherein said releasable material is mixed with said host material by melt compounding in a twin screw extruder.

77. A formulation as claimed in claim 64 wherein said solid cleaning particles may be polymeric and/or non-polymeric cleaning particles, optionally wherein said polymeric cleaning particles comprise polyalkenes, polyamides, polyesters or polyurethanes, and optionally wherein said non-polymeric cleaning particles comprise particles of glass, silica, stone, wood, metal or ceramic materials.

78. A formulation as claimed in claim 77 wherein said polymeric cleaning particles comprise copolymers comprising monomers which are ionically charged or include polar moieties or unsaturated organic groups.

79. A formulation as claimed in claim 64 wherein said dosing particles are added at a ratio of from 0.1-50.0% w/w of the total mass of said formulation and/or wherein said dosing particles are substantially cylindrical or spherical in shape, and/or wherein said dosing particles have an average density in the range of 0.5-2.5 g/cm³ and an average volume in the range of 5-275 mm³.

80. A formulation as claimed in claim 64 wherein said dosing particles are re-usable in further substrate treatments.

81. A method for the treatment of a substrate, said method comprising the treatment of the substrate with a formulation as claimed in claim 64.

82. A method as claimed in claim 81 wherein said method is performed in an aqueous environment in the presence of limited quantities of water.

83. A method as claimed in claim 81 which comprises a method for the cleaning of a soiled substrate, wherein said at least one releasable material comprises at least one cleaning agent.

84. A method as claimed in claim 81 wherein said at least one releasable material comprises at least one post-cleaning agent.

85. A method as claimed in claim 81 wherein said dosing particles comprise additives which are free from cleaning agents.

86. A method as claimed in claim 81 which comprises the release of an antimicrobial agent onto a fabric surface for sterilisation purposes.

87. A method as claimed in claim 81 which comprises the treatment of a fabric with at least one anti-redeposition agent, preferably wherein said at least one anti-redeposition agent is selected from CMC, polyacrylates, polyethylene glycol (PEG), poly(vinyl pyrrolidone (which may be crosslinked or uncrosslinked), sodium bentonite, and chitosan, or salts thereof.

88. A method as claimed in claim 81 wherein said solid cleaning particles are added at a particle to substrate addition level of from 30:1 to 0.1:1 by dry mass of substrate, or wherein the ratio of solid cleaning particles to substrate is in the range of from 10:1 to 0.1:1 w/w by dry mass of substrate, or wherein said ratio is between 5:1 and 1:1 by dry mass of substrate.

89. A method as claimed in claim 81 wherein said substrate comprises plastics materials, leather, paper, cardboard, metal, glass or wood.

90. A method as claims in claim 81 wherein said substrate comprises a textile fibre, optionally wherein said textile fibre comprises a natural fibre or a synthetic fibre or a blend thereof.

91. A method as claimed in claim 81 wherein water is added to the system so as to provide a water to substrate ratio which is between 2.5:1 and 0.1:1 w/w, or between 2.0:1 and 0.8:1.

92. A method as claimed in claim 81 for the cleaning of textile fibres and fabrics, wherein said treatment is performed at temperatures of between 5 and 95° C. for a duration of between 10 minutes and 1 hour.

93. A method as claimed in claim 81 wherein said solid cleaning particles are re-used in further procedures according to the claimed method and/or said dosing particles are re-used in further procedures according to the claimed method.

94. A method as claimed in claim 81 for the cleaning of a soiled substrate, said method comprising, in sequence, the steps of:
(a) washing the soiled substrate with a multiplicity of solid cleaning particles and a multiplicity of dosing particles;
(b) performing a first extraction of excess water;
(c) performing a first separation of said solid cleaning and dosing particles;
(d) rinsing;
(e) performing a second extraction of excess water;
(f) optionally repeating steps (d) and (e) at least once; and
(g) performing a second separation of said solid cleaning and dosing particles.

95. A method for the cleaning of a cleaning apparatus, said method comprising the treatment of the internal systems of the apparatus with a formulation comprising a multiplicity of solid cleaning particles and a multiplicity of dosing particles, wherein said dosing particles comprise at least one host material and at least one releasable material, wherein said host material comprises at least one partially or completely water soluble polymeric material and said at least one releasable material comprises an antimicrobial agent.

96. A method for the removal of dosing particles or residues thereof from a cleaning apparatus during or after the treatment of a substrate, said method comprising the solubilisation of said dosing particles, optionally wherein the temperature or pH of the system is adjusted so as to solubilise the insoluble material of the dosing particles.
